(19) United States
(12) Patent Application Publication
(10) Pub. No.: US 2015/0043645 A1
(43) Pub. Date: Feb. 12, 2015

(54) VIDEO STREAM PARTITIONING TO ALLOW EFFICIENT CONCURRENT HARDWARE DECODING

(71) Applicant: Jaakko Tuomas Aleksi Ventelä, Oulu (FI)

(72) Inventor: Jaakko Tuomas Aleksi Ventelä, Oulu (FI)

(73) Assignee: GOOGLE INC., Mountain View, CA (US)

(21) Appl. No.: 13/528,641

(22) Filed: Jun. 20, 2012

(51) Int. Cl. H04N 7/26; H04N 7/32

(52) U.S. Cl. 375/240.16; 375/240.24; 375/E07.125; 375/E07.027

(57) ABSTRACT

Systems and methods are provided herein relating to decoding and encoding. A decoder component concurrently decodes coefficient blocks from separate data streams received. A stream decoder initiates the decoding process and provides coefficient data downstream to a single decoding pipeline. The stream decoder includes a plurality of sub stream decoders with associated buffers that enable decoding coefficients of a macroblock concurrently in a single processing pipeline. The sub stream decoders receive different sub-partitions of the macroblock from different data streams of encoded video data. The decoder component is thus operable to concurrently decode the sub-partitions, which are received from separate data streams, within a single decoding pipeline.

### TECHNICAL FIELD

This disclosure generally relates to video stream partitioning, and, more particularly, to decoding video stream partitions of media data.

### BACKGROUND

Transmitting digital video information over communication networks can consume large amounts of bandwidth, especially if the amount of data representing media content is extremely large. Typically, higher bit transfer rates are associated with increased cost. For example, higher bit rates can progressively add to storage capacities of memory systems. Depending upon the given quality level, the cost of storage can be effectively reduced by using fewer bits, as opposed to more bits, to store digital content (e.g., images or videos), such as with data compression.

Data compression is a technique to compress media data for recording, transmitting, or storing in order to efficiently reduce the consumption of resources. Compression standards continue to improve, and thus, provide better compression of video images. However, a downside to the increased compression efficiency is that decoder complexity increases.

For example, encoding and decoding of media data (e.g., video images) can be done on many different platforms, but the encoding of video images is usually done on high performance computer systems since one master video sequence can be encoded to a suitable distribution format. The decoding of the video sequence can then be done on many different systems, from general purpose computers to set-top boxes, mobile phones, hand held media players and the like. The complexity of encoders and decoders can be large due to tight feedbackloops between context modeler components and arithmetic coder components in the hardware. One of the main bottlenecks in the decoding process is with the arithmetic coder component because all encoded data is processed in a sequential way. Because of difficulty in designing around the arithmetic decoder, all data in a bitstream pass through an entropy decoder before the other subcomponents of the decoding processing pipeline are able to start decoding, such as in motion compensation components, transform processes, and the like. A potential advantage therefore exists in further improving the decoding pipeline processes by mitigating or even eliminating the bottlenecks with solutions that are not cost prohibitive.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular implementations of the specification, or any scope of the claims. Its sole purpose is to present some concepts of the specification in a simplified form as a prelude to the more detailed description that is presented in this disclosure.

Systems and methods disclosed herein relate to video decoding and decoding video stream partitions from various data streams of media data. A decoder component receives an input media stream (e.g., communicated media data) that has a plurality of data streams that are associated with sub-partitions of a macroblock (e.g., a two dimensional block area of pixels), such as a 16×16 pixel block frame. The decoder component includes a processing pipeline that further decodes the sub-partitions of a macroblock concurrently from the plurality of data streams without additional processing pipelines.

In one embodiment, a system includes a single processing pipeline for decoding input data streams having sub-partitions of a macroblock. A decoding component includes a stream decoder that has a plurality of sub stream decoders communicatively connected to a plurality of buffers. The decoder component receives the data streams and initiates decoding of coefficient blocks concurrently via the stream decoder. Each data stream can be associated with a separate sub-partition of the macroblock, and thus, separate sub-partitions of each macroblock can be decoded concurrently in the single processing pipeline.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a high level functional block diagram of a system in accordance with one exemplary aspect of an embodiment;

FIG. 2 illustrates a high-level functional block diagram of an example macroblock and macroblock sub-partitions in accordance with implementations of this disclosure;

FIG. 3 illustrates a high-level functional block diagram of an example system that decodes encoded macroblocks in accordance with implementations of this disclosure;

FIG. 4 illustrates a high-level functional block diagram of an example decoder component with sub stream decoders that decode encoded macroblocks for a reconstructed video in accordance with implementations of this disclosure;

FIG. 5 illustrates a high-level functional block diagram of an example decoder component that generates a reconstructed video stream including a display component in accordance with implementations of this disclosure;

FIG. 6 illustrates a high-level functional block diagram of an example system that decodes encoded macroblocks in accordance with implementations of this disclosure;

FIG. 7 illustrates an example chronological processing flow for decoding a macroblock in accordance with implementations of this disclosure;

FIG. 8 illustrates an example method for decoding an input media stream in accordance with implementations of this disclosure;

FIG. 9 illustrates an example method for video decoding in accordance with implementations of this disclosure;

FIG. 10 illustrates an example block diagram of a computer operable to execute the disclosed architecture in accordance with implementations of this disclosure; and

FIG. 11 illustrates an example schematic block diagram for a computing environment in accordance with the subject specification in accordance with implementations of this disclosure.

### DETAILED DESCRIPTION

### Overview

Serial bit stream processing can be a bottleneck for high definition video coding because it cannot be easily parallelized. For example, bit streams can serially deliver independent slices of a split image frame from among a sequence of image frames (e.g., macroblocks) that compose a video or other multimedia streaming content. However, splitting each image frame into independent slices decreases the compression ratio of the streaming content and is not efficient for pipelined hardware accelerators. Video standards, therefore, provide video stream partitions that are parallel processed in multiple pipelines driven by multi-core processing. For example, in order to take advantage of streaming content in slices, a hardware decoder pipeline is duplicated so that the sum of each pipeline bit rate would equal the total bit stream rate of the input stream and prevent decoding delays in the decoding hardware. Otherwise, slices of the image frame can be delayed while a previous partition slice is being decoded.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

Because duplicating entire decoding pipelines can be unfeasible due to semiconductor die space, providing macroblock sub-partitioning to the video standards used for data compression streaming can enable a high bit rate performance by the decoder hardware architectures. In one embodiment, a hardware decoder decodes coefficient blocks of a macroblock concurrently in a single processing pipeline. Coefficient blocks from a macroblock are received from separate streams at a stream decoder and processed concurrent to one another in a predetermined order. At least two different data streams are received with corresponding sub-partitions of a macroblock within the media data. A sub-partition includes a sequence of coefficient block(s) within the macroblock, and multiple sub-partitions are received together in multiple corresponding data streams. Each data stream is thus processed and decoded through the single pipeline concurrently according to the coefficient blocks of each sub-partition, which can result in an increase in the hardware decoding speed of the hardware decoder.

### Example Video Stream Partitioning to Allow Efficient Concurrent Hardware Decoding

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

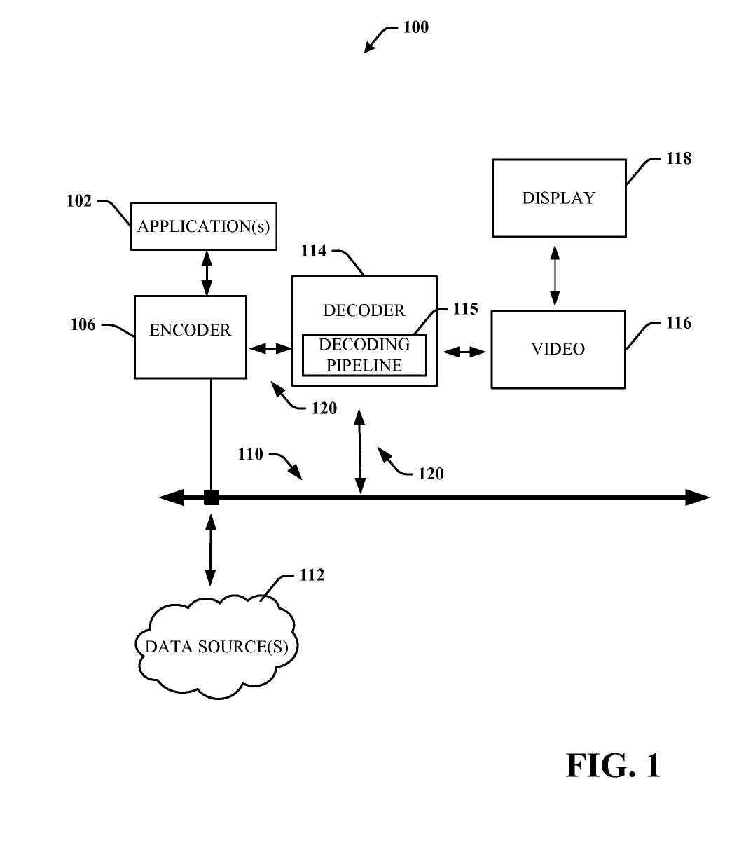

Referring now to FIG. 1, illustrated is an example system 100 that concurrently decodes coefficient blocks from a macroblock. A macroblock of video data represents a data compressed image of a pixel area (e.g., a 16×16 pixel area) within a picture or frame among a sequence of frames that is encoded from raw video data. For example, a VP8 format media stream is partitioned into a control partition and one or more residual partitions according to macroblock rows. The system 100 retrieves compressed video data from an external source or receives the video data from an input media stream, and decodes macroblocks of the data into a reconstructed video to a user.

The system 100 includes a user mode application 102 in either a remote client device (not shown) or an encoder 106. In one example of an embodiment, the encoder 106 partitions a macroblock of a sequence of raw video images based on a header, luminance data and chrominance data. For example, the header of the macroblock is encoded into a first partition, the luminance data of the macroblock is partitioned into at least a second partition and a third partition and the chrominance data of the macroblock is partitioned into fourth partition and a fifth partition. Additionally or alternatively, the luminance data of the macroblock is partitioned into four different partitions. These partitions can also be considered sub-partitions of the macroblock as described below. The partitions or sub-partitions are then communicated to a decoder for decoding into a reconstructed video for a user.

The user mode application 102 requests various system functions by calling application programming interfaces (APIs) for invoking a particular set of rules (code) and specifications that various computer programs interpret to communicate with each other. The encoder device 106 includes a device that converts data from one format or code to another, such as a computer device, a set-top box, mobile phone, hand held media player, and the like. A bus 110 permits communication among the components of the system 100. The device 106 includes processing logic that may include a microprocessor or application specific integrated circuit (ASIC), a field programmable gate array (FPGA), or the like. The device 106 may also include a graphical processor (not shown) for processing instructions, programs or data structures for displaying a graphic, such as a three-dimensional scene or perspective view.

The encoder device 106 is coupled to a decoder component 114 that is operable to detect a compressed video sequence or data compression sequence and retrieve the detected sequence from a data source 112 or from a delivered media stream 120 at a decoding pipeline 115. The decoder component 114, for example, receives the encoded macroblock in partitions or sub-partitions corresponding to each data streams of a plurality of data streams. The decoder component 114 communicates via the bus 110 or another transmission medium that may be a wired and/or a wireless transmission medium. The decoder component 114 is communicatively connected to a display 118, which can be a remote display or a display screen at the encoder device 106. The decoder component 114 processes the input media stream 120 having sequences of macroblock data of compressed media content into a video that is rendered by a video component 116 to a user as a reconstructed video, for example.

In one embodiment, the decoder component 114 is configured to decode coefficient blocks associated or related to each macroblock concurrently, at substantially the same time, and/or at the same time. In addition, the decoder component 114 can decode the coefficient blocks of two or more separate data streams concurrently or simultaneously, at the same time, and/or substantially simultaneously. For example, the decoder component 114 receives a macroblock of a plurality of macroblocks in a sequence within the input data stream 120, and operates to decode the macroblock. The input data stream 120 can be received on the communication bus 110, such as from the encoder device 106 and/or from an external data source 112. Additionally, the input data stream can be received directly from an external device.

The decoder component 114 is configured to receive the input data stream 120 as multiple different data streams that each have one or more sub-partitions, in which components of the decoder component are configured to ascertain or detect and further decode. Although the decoding component 114 is illustrated with the single decoding pipeline 115, the decoding component 114 can also have multiple decoding pathways for processing macroblocks concurrently. However, the decoding component 114 can decode each sub-partition of a macroblock concurrently with the single decoding pipeline 115.

The term “concurrent” or “concurrently” can be defined herein as overlapping at some point in time, along with an ordinary definition of the term. For example, a coefficient block of a sub-partition of a macroblock is processed via the decoder component 114 together with another coefficient block of another sub-partition of the same macroblock. The decoding component 114 executes the decoding process on more than one coefficient block at the same time, together in time, at substantially the same time and/or any concurrent combination when information from one coefficient decoding is used to begin another, but the processing is overlapping (e.g., a first coefficient is decoded with a second coefficient, but decoding of the first coefficient can initiate before the second coefficient initiates so that decoding overlaps and occurs concurrently among coefficient blocks).

In one aspect of an embodiment, the decoder component 114 performs the decoding process of each macroblock, which is the inverse of an encoding process performed on raw video data. Initially, the decoder component 114 receives the input media stream 120 with multiple data streams, and each data stream is received and processed separately and concurrently to one another. Sub-partitions of each macroblock are also processed together concurrently in the same decoding pipeline 115. As a result, the expense of multiple processing pathways can be saved, and are not necessary for parallel processing in order to achieve a four to five times increase in processing speed.

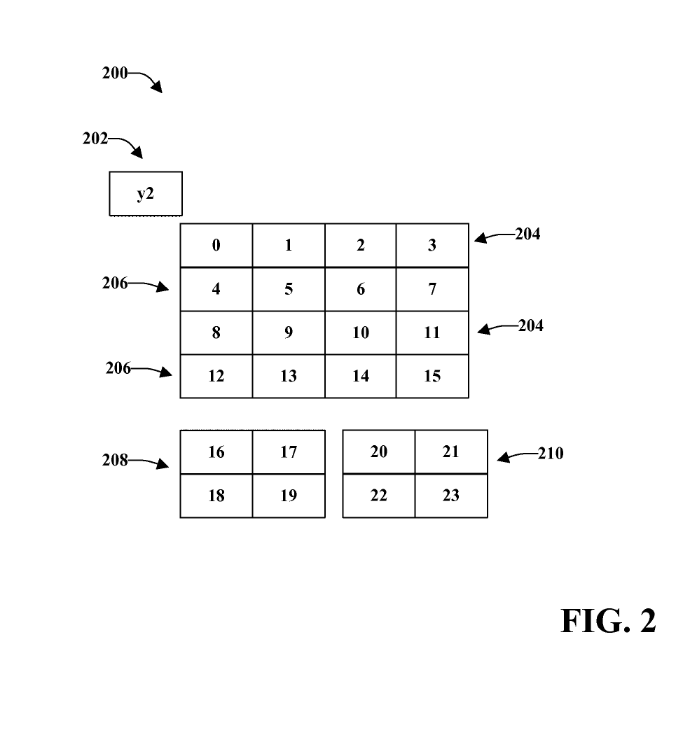

Referring to FIG. 2, illustrated is an exemplary macroblock 200 configuration. The macroblock 200 defines a pixel size area of an image frame among a sequence of video image frames. For example, the macroblock 200 is a 16×16 pixel size area as expressed by the number of luminance coefficient blocks. Although the macroblock 200 is illustrated as a 16×16 pixel size area, the macroblock 200 is not limited to any particular pixel area size.

The macroblock 200 includes a header coefficient, a set of luminance coefficient blocks (e.g., labeled 0 through 15 luminance coefficient blocks) and two sets of chrominance blocks (e.g., labeled 16 through 19, and 20 through 23) included in sub-partitions of each macroblock. A macroblock may include at least two or more sub-partitions, such as seven sub-partitions. The macroblock 200, for example, includes different sub-partitions that have one or more coefficient blocks of data, which represent compressed video information (e.g., spatial frequency information). More specifically, in FIG. 2, the macroblock 200 has five sub-partitions (202, 204, 206, 208, and 210). Each macroblock is communicated in a sequential input media stream and includes two or more different sub-partitions, which are transmitted to the decoder, or retrieved from a data store by the decoder. In one embodiment, the decoder receives five different data streams corresponding to each sub-partition of the macroblock 200.

In the example of FIG. 2, the Macroblock 200 includes a first sub-partition 202 (y2 block) that provides information specifying how coefficient data of the macroblock is coded. A second sub-partition 204 and a third sub-partition 206 include different luminance coefficient blocks of compressed luminance image data. The second sub-partition 204 includes coefficient blocks designated 0 to 3 and 8 to 11, and the third sub-partition 206 includes coefficient blocks designated 4 to 7 and 12 to 15, for example. The macroblock 200 further includes a fourth partition 208 and a fifth partition 210 that include coefficient blocks of chrominance image data. The sub-partitions of the macroblock 200 can be transmitted separately in different data streams of the input media stream 120 and received together by the decoder component 114 for decoding in a processing pipeline.

For color image data, each pixel of an image data may be expressed in different formats such as YCbCr (or some other format), in which in the YCbCr format, the Y represents luminance data and the Cb and Cr represent chrominance data. Each pixel of image data is thus represented by three values, one for luminance and two for chrominance. As a result of human vision parameters, the chrominance values can be sub-sampled to reduce the data volume before being compressed at an encoder without compromising perceived image quality. Image data represented by chrominance portions may be sub-sampled, for example, by using a 4 to 1 sub-sampling ratio, where the size of the chrominance blocks is a quarter of the luminance block of data. In this example, the input media stream received by a decoder component may include four luminance blocks for every two chrominance blocks of data. This pattern can be repeated for each of the macroblocks in the input media stream 202 having compressed media data. Individual quantized DC coefficients of each luminance block of compressed data can be extracted in the decoding process to obtain a corresponding 16×16 block of image data outputs.

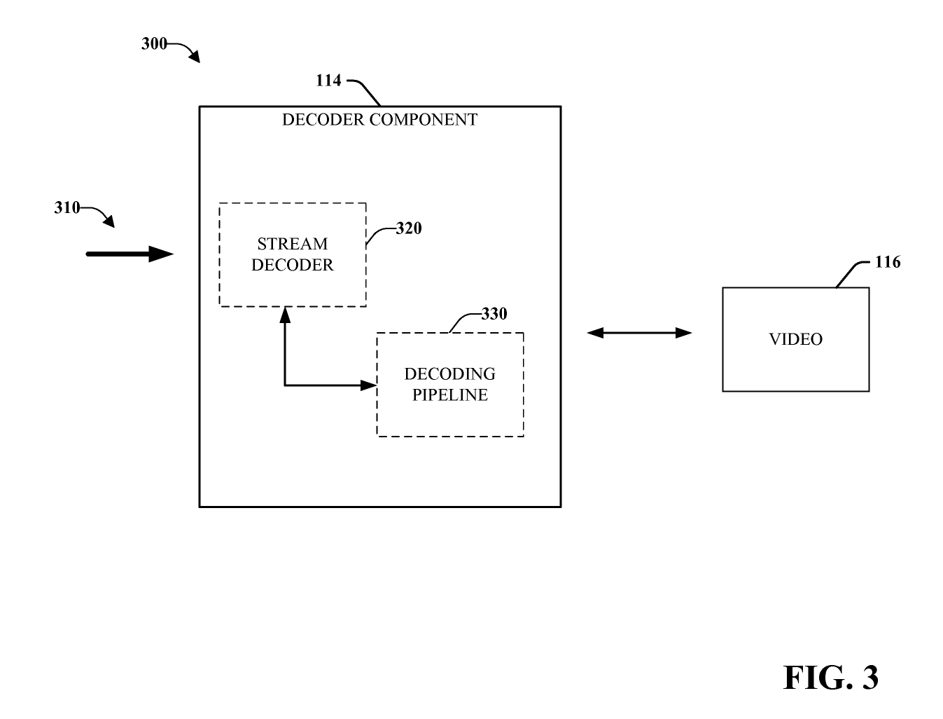

Referring now to FIG. 3, illustrated is the decoder component 114 that converts an input media stream 310 into a reconstructed video 116. The decoder component 114 receives an input media stream 310 that can include a plurality of input data streams, in which each data stream may correspond to one or more of sub-partitions of a macroblock. The decoder component 114 decodes sub-partitions of the input stream 310 concurrently, and outputs the reconstructed video 116 for a user. The decoder component 114 includes a stream decoder 320 that is operatively connected to a decoding pipeline 330.

The stream decoder 320 and the decoding pipeline 330 are communicatively coupled together to form a single processing pipeline in the decoder component 114 to decode the input media stream 310 The decoding processes, for example, can be similar to an inverse process of the encoding process. Due to some acts of the encoding process (e.g., quantization), the output image frames after decoding may not be the exact same as the original raw data image. Although, the degree of lossness can be controlled within the decoding pipeline (e.g., via a quantization matrix) to be within a predetermined tolerance.

The stream decoder 320 converts the input bit stream of coefficient data into intermediate symbols of data that are outputted to the decoding pipeline 330 for further decoding. The decoding pipeline 330 receives symbols of data generated from the coefficient data from sub-partitions of each macroblock. The decoding pipeline further decodes the different sub-partitions of each macroblock in different phases of decoding.

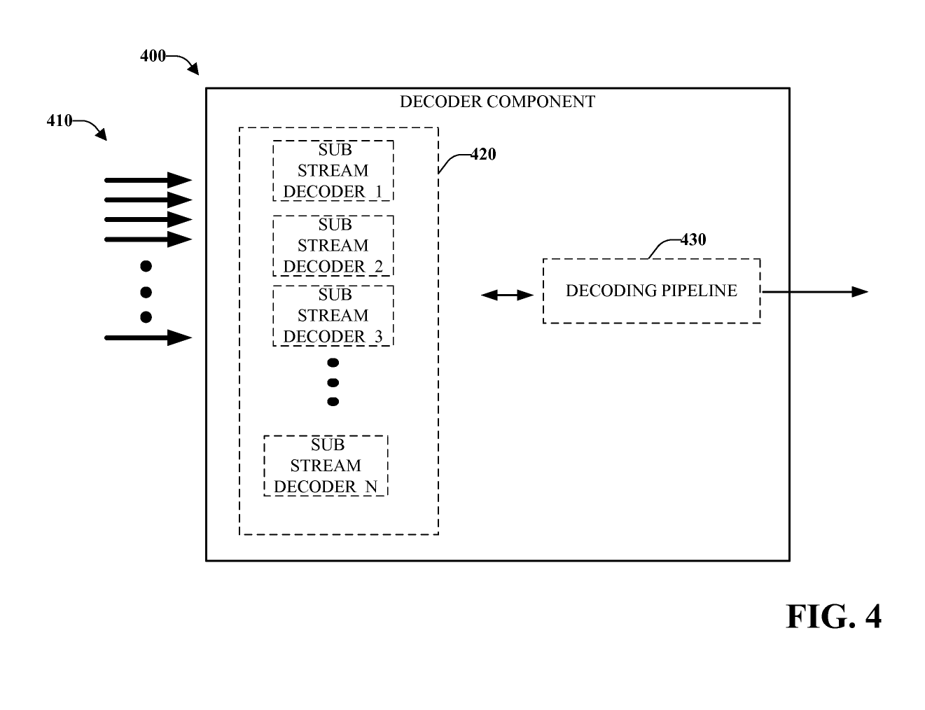

Referring now to FIG. 4, illustrated is a decoder component 400 that decodes macroblocks from an encoded media stream. The decoder component 400 includes a stream decoder 420 that receives a plurality of input data streams 410, and a decoding pipeline 430 that further decodes the output of the stream decoder 420 into a reconstructed video stream.

The stream decoder 420 has a plurality of sub stream decoders including sub stream decoder 1 through sub stream decoder N that receives, retrieves or obtains, either from a transmission or from an external data store, macroblock data in the data streams 410. In one embodiment, the number of data streams received at the decoder 400 can depend upon the number of sub-partitions of the macroblock. For example, if the macroblocks in the input media stream received have three sub-partitions, then the stream decoder 420 may include at least three sub stream decoders. The input media stream thus includes data streams that are partitioned into sub-partitions of rows of the macroblock.

The sub stream decoders 1 thru N are operatively connected within a single processing pipeline. For example, sub stream decoder 1, sub stream decoder 2, sub stream decoder 3, and thru sub stream decoder N are operatively connected to the decoding pipeline 430 to decode the data streams 410, which include encoded compressed bits of macroblock data. Because the decoding bit rate of other components within the decoding pipeline 430 is higher than the stream decoder 420, the decoding pipeline is not multiplied to concurrently process the sub-partitions of each macroblock received. Additionally, the stream decoder 420 is operable to receive multiple sub-partitions of each macroblock from multiple data streams 410 at sub stream decoders 1 thru N, which enables concurrent processing of sub-partitions throughout a single processing pipeline of the decoder component 400.

For example, the first sub-partition 202 of the macroblock 200 in FIG. 2 can be received at the sub stream decoder 1 and transmitted in a separate data stream at substantially the same time or concurrent to other data streams having other sub-partitions. Similarly, the second sub-partition 204 may be received in a different data stream at sub stream decoder 2, and so on with other sub-partitions of the macroblock 200, so that the sub-partitions of the macroblock 200 are received together and decoded concurrently within the stream decoder 420 and downstream through the decoding pipeline 430.

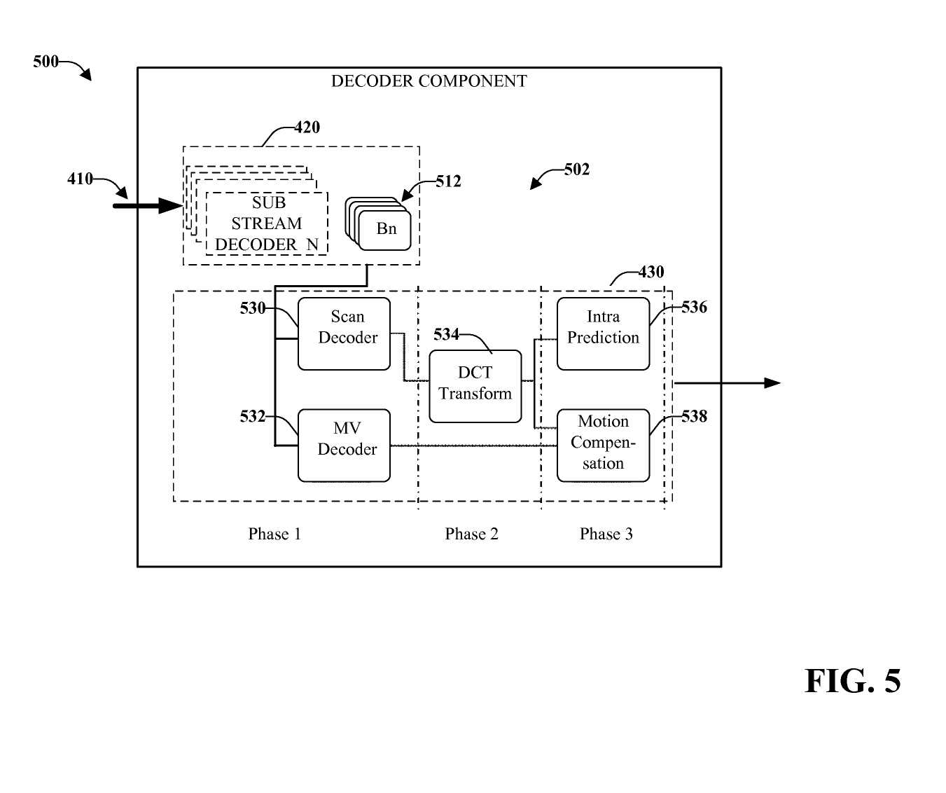

FIG. 5 illustrates additional exemplary aspects of one embodiment of a decoder component that decodes an encoded input media stream to render a reconstructed video to a user in accordance with various aspects of this disclosure. A decoder component 500 includes a single processing pipeline 502 that includes a chain of decoding component phases configured so that the output of each phase is the input of the next phase of decoding.

For example, phase 1, phase 2 and phase 3 of the decoding pipeline 430 sequentially decodes macroblock data. While phase 2 continues the decoding process on a first macroblock, phase 1 can initiate decoding of a second macroblock. Each phase of the decoding pipeline 430 includes different decoding components to generate a reconstructed video from a plurality of data streams 410.

The decoder component 500 receives input data stream 410, which is a compressed bitstream from video data stored on an external data store (e.g., a hard disk or the like) or transmitted over a communication line. A stream decoder 420, for example, has a plurality of sub stream decoders N that decode the different sub-partitions of each macroblock. The stream decoder 420 further includes a plurality of buffers 512 that operate as addressable data stores for the decoding pipeline 430. For example, the plurality of buffers 512 can operates to provide data from each sub decoder component to the decoding pipeline 430, which can address the data stored in the buffers in any particular order. The plurality of buffers 512 can also operate as a plurality of caches to cache decoded coefficient data from the plurality of sub stream decoders N so that the data can be retrieved in increments, rather than all at once by the decoding pipeline 430. Alternatively, the plurality of buffers 512 can operate as both buffers and caches for transferring decoding information onto the decoding pipeline 430. The phases of decoding by the decoder pipeline 430 and accompanying components are commonly known by one of ordinary skill in the art and so are discussed briefly below.

Phase 1 of the decoding pipeline 430 includes the stream decoder 420, a scan decoder 530 and a motion vector (MV) decoder 532. The scan decoder 530 scans the data received from each sub stream decoder to order the set of data into scanned data to be transformed and/or scaled in phase II. The motion vector decoder 532 derives motion vectors for a compressed video frame of a video frame sequence based on a reference video frame, which is typically a prior video frame in the sequence. The derived motion vectors can then be used to predict the translational displacement of objects coded within the bitstream of the input media stream being decoded. Phase II of the decoding pipeline 420 includes a discrete cosine transform component 534 that operates to perform an inverse discrete cosine transform on the scanned data from the scan decoder 530. Phase III of the decoding pipeline 420 includes a motion compensation component 536 that uses a reference block and motion vector information in order to predict the motion compensation. An intra prediction component 538 performs decoding relative to the information that is contained within each macroblock according to one or more algorithms.

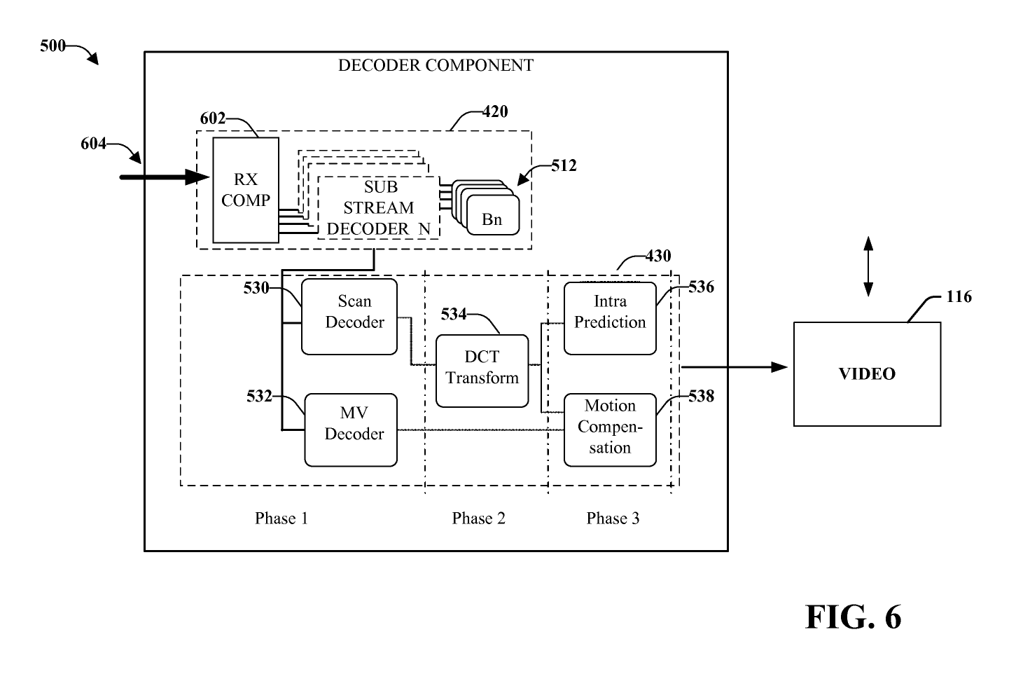

FIG. 6 illustrates an exemplary decoder component in accordance with various aspects of this disclosure. The decoder component 500 includes the stream decoder 420 that includes a plurality of sub stream decoders N coupled to a receiving component 602 and a plurality of buffers Bn 512. The receiving component 602 is operable as a transceiver for transmitting and receiving data. The receiving component 602 can receive an input media stream 604 (e.g., compressed video bit stream) having certain criteria (e.g., bit rate, compression standard, etc.). The input media stream can include various sub-partitions of residual slices of coefficient data within a macroblock. For example, the input media stream may be partitioned according to sub-partitions of residual partitions generated from a macroblock of an image frame. Each sub-partition, which includes one or more coefficient factors of visual data that is compressed, can be transmitted by a different data stream and received by the receiver component 602. The receiver component 602 analyzes the input media stream and can allocate the information of each data stream to a corresponding sub stream decoder of the plurality of sub stream decoders N. A dedicated sub stream decoder N for each sub-partition of the macroblock is therefore enabled so that each sub stream decoder N decodes the same sub-partition portion of each macroblock in a sequence of macroblocks for a compressed video stream.

Decoding is initiated in the stream decoder 420 for each data stream having a separate sub-partition for a macroblock. The coefficients are thus decoded concurrently within each sub-partition. Due to inter-relational dependencies within each macroblock certain sub-partitions may be initiated before other sub-partitions of the macroblock. The buffers Bn 512 therefore receive coefficient data that has been decoded in the stream decoder and releases each of the data for processing in the decoding pipeline 430, such as with the scan decoder 530 and/or the motion vector decoder 532. Therefore, processing speeds for stream decoding in the stream decoder 420 is enhanced by concurrently processing separate streams of a macroblock in order to eliminate the bottlenecks that the stream decoder can cause while maintaining a single processing pipeline. For example, in many cases a stream decoder can keep up with the rest of the decoding pipeline 420, but in prior art decoding architectures this is not necessarily always the case with high bit rate stream decoding. The decoder component 500 and other embodiments disclosed herein enable significant advantages to performance when video stream bit rate increases. In particular, the arithmetic coding schemes used in many video coding standards can be very serial, difficult to parallelize and sensitive to high bitrates. The decoder components described in this disclosure can allow for a four to five times faster decoding.

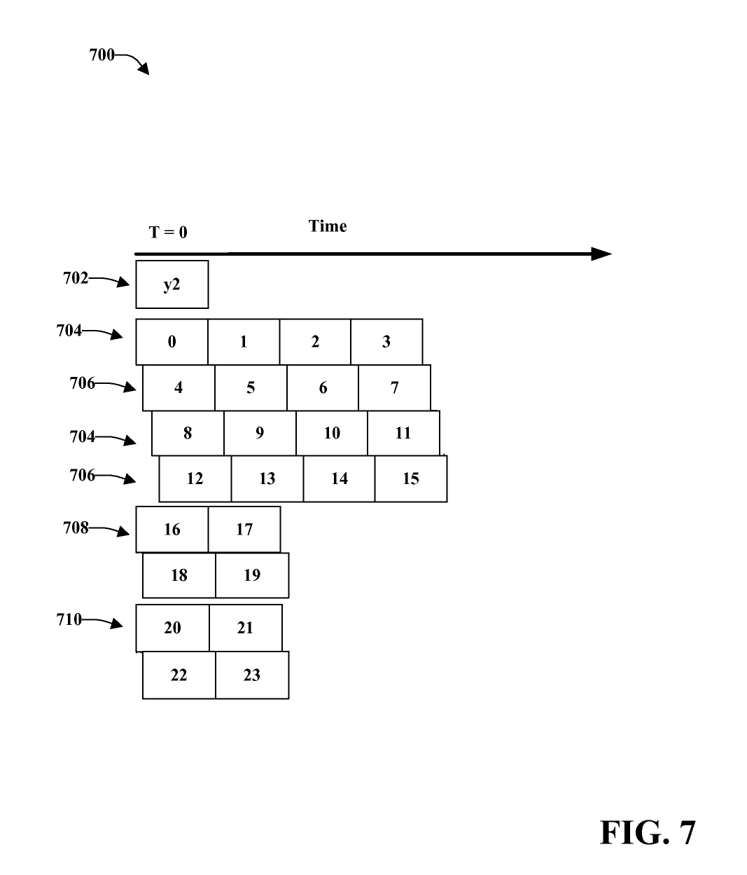

Referring now to FIG. 7, illustrated is a chronological processing order for an exemplary decoder component in accordance with various aspects of this disclosure. The decoder disclosed herein decodes a macroblock according to at least two or more multiple different data streams (e.g., encoded video streams). For example, the macroblock is received in separate streams that corresponding to different sub-partitions of the macroblock. The macroblock, for example, includes a first sub-partition 702, a second sub-partition 704, a third sub-partition 706, a fourth sub-partition 708 and a fifth sub-partition 710. While five sub-partitions are illustrated for the macroblock, a different number, such as a number greater than two is also envisioned (e.g., four or seven). At time T=0, the first sub-partition 702, the second sub-partition 704, the fourth and fifth sub-partition are decoded at the same time and/or concurrently. Sub-partitions 2 and 3 have some interdependencies that can predetermine a certain order of decoding based on the interdependencies. For example, decoding of coefficient block zero within the second sub-partition 704 is started before coefficient block 4 of the third sub-partition. In a further example, decoding of coefficient block 1 is initiated before block five, and so on. Thus, a contiguous coefficient block that is above another lower coefficient block is initiated first in the decoding process in a decoding component before the lower coefficient block. This can provide for a substantial increase in overall decoding speed of each macroblock compared to a single stream decoding order. For example, many of the components within a decoding pipeline, as described above, have faster decoding rates than the stream decoder. By enabling concurrent decoding of coefficient blocks from separate streams inside of a macroblock, such as at the beginning of the decoder component with the stream decoder, the entire decoding processing pipeline is made faster.

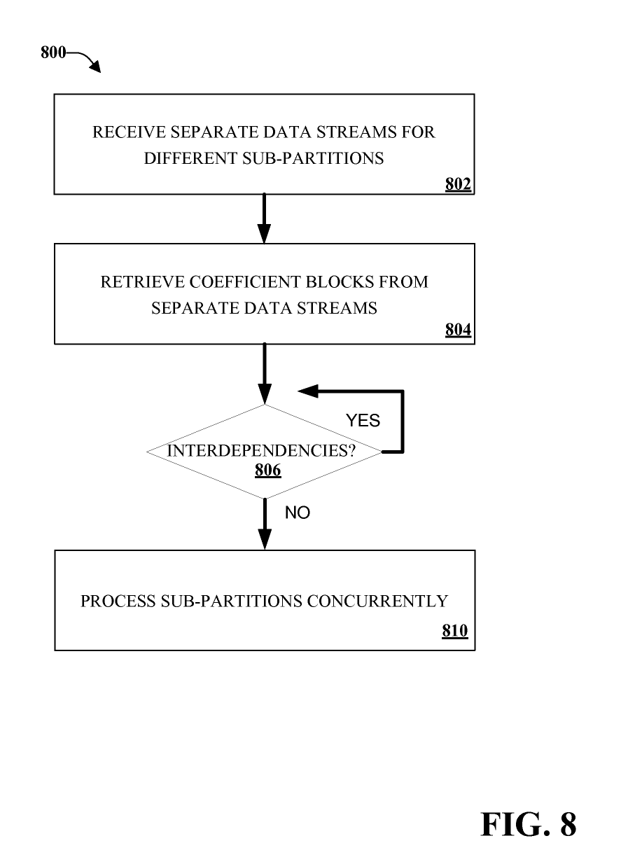

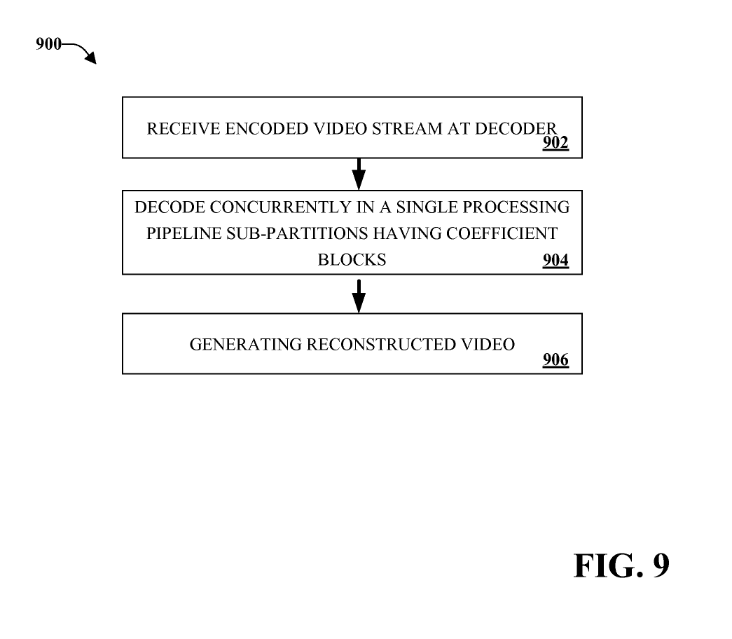

FIGS. 8-9 illustrate methodologies and/or flow diagrams in accordance with this disclosure. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Moreover, various acts have been described in detail above in connection with respective system diagrams. It is to be appreciated that the detailed description of such acts in the prior figures can be and are intended to be implementable in accordance with the following methodologies.

FIG. 7 illustrates an example method for a decoder hardware component or software component to concurrently decoder sub-partitions of a macroblock in accordance with implementations of this disclosure. At 802, separate data streams are received at a decoder component. The data streams can be received separately at about the same time, or together as one input stream and then separated according to the architecture of the decoder, for example. The macroblock includes coefficient blocks that are from an encoding process of pixel image data. Rows of the macroblock are further portioned into sub-partitions of coefficient blocks and communicated to the decoder pipeline.

At 804, the decoder retrieves coefficient blocks from the separate data streams. The coefficient blocks, for example, can be retrieved from different sub-partitions of the data streams, which can correspond to a particular sub-partition for each macroblock within the sequence of encoded video data. Sub stream modules, additionally, can correspond to the different sub-partitions respectively. The sub stream modules can retrieve the one or more coefficient blocks from the different sub-partitions and concurrently initiate decoding.

At 806, a determination is made as to whether interdependencies exist between any two or more sub-partitions and the coefficient blocks therein. If the answer is yes, then the two or more sub-partitions examined are not processed concurrently, and another two sub-partitions are examined for the determination. At 810, coefficients of the sub-partitions without interdependencies are concurrently processed. In one embodiment, the sub-partitions having interdependencies are decoded according to the interdependencies determined and concurrent to other sub-partitions. For example, coefficients above lower coefficients of a macroblock initiate decoding before and are decoded concurrent along with the lower contiguous coefficient in the macroblock.

In another embodiment, the coefficients having interdependencies can be queued in a coefficient buffer so that while an above coefficient is being processed a lower coefficient is temporarily stored before decoding initiates.

FIG. 9 illustrates an example video decoding method 900 for decoding a macroblock in accordance with implementations of this disclosure. At 902, an encoded video stream is received at a decoder component. At 904, a plurality of sub-partitions that have one or more coefficient blocks of pixel data associated with a macroblock of the video stream are decoded concurrently, such as by a stream decoder 420 that includes a plurality of sub stream decoders, as part of a single processing pipeline. At 906, a reconstructed video is generated using the substantially concurrently decoded coefficient blocks of each macroblock received in the encoded video stream.

In one embodiment, the method 900 includes can receive a first sub-partition of the macroblock at a first sub stream decoder and a second sub-partition of the macroblock being received at a second sub stream decoder. The first sub-partition is decoded concurrently with the second sub-partition in the single processing pipeline to generate the reconstructed video. The encoded video stream includes the first and second sub-partitions in a plurality of separate data streams that are associated with each macroblock.

The method 900 can further include decoding the separate data streams concurrently in a predetermined order. Each data stream of the plurality of separate data streams, for example, is associated with at least one of the different sub-partitions of the macroblock received by the stream decoder at a bit rate greater than about 1500 kbits/s, a picture size of 352×288 pixels, and a frame rate of 30 frames per second (fps). The following chart is an example of metrics for a hardware implementation performance when video stream bitrate increases:

| Bitrate | Frame | Picture size | clock cycles/ | clock cycles/ |
|---|---|---|---|---|
| [Kbits/s] | Rate | pixels | MB average | MB peak |
| 500 | 30 | CIF 352 × 288 | 420 | 691 |
| 1000 | 30 | CIF 352 × 288 | 741 | 1168 |
| 1500 | 30 | CIF 352 × 288 | 969 | 1540 |

The decoder disclosed herein can be implemented in hardware, software or a combination of both. In software implementations, the components in the decoder can be software instructions stored in memory of a computer and executed by the processor and video data stored in the memory. A software decoder can be stored and distributed on a variety of convention computer readable media. In hardware implementations, the decoder components are implemented in digital logic in an integrated circuit. Some of the decoder functions can be optimized in special-purpose digital logic devices in a computer peripheral to off-load the processing burden from a host computer, for example.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

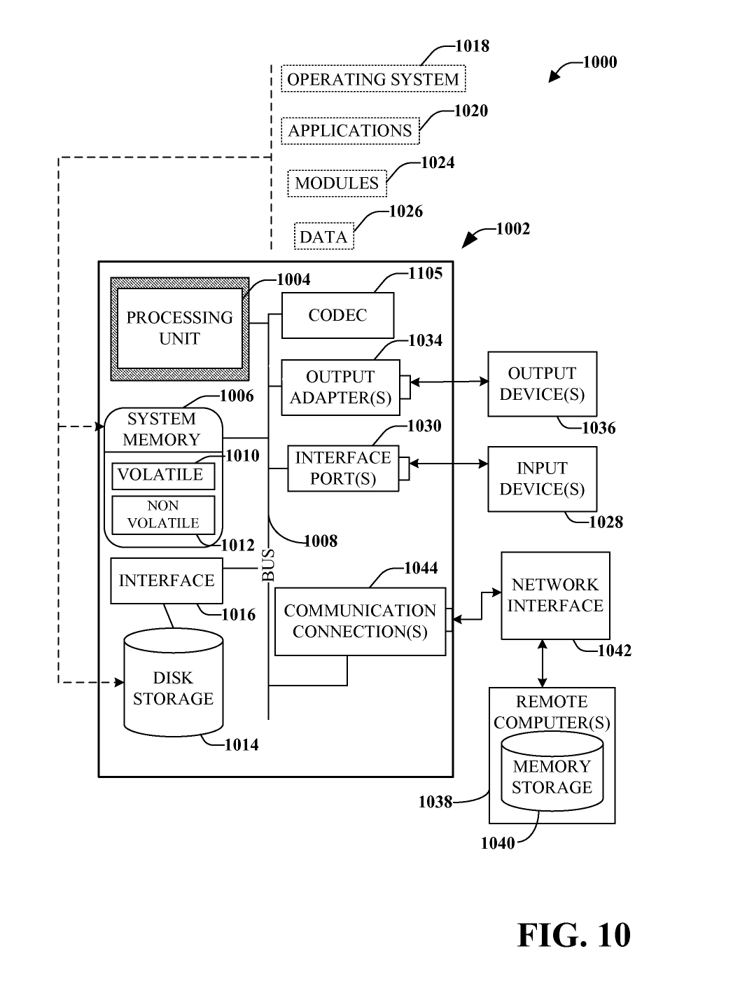

With reference to FIG. 10, a suitable environment 1000 for implementing various aspects of the claimed subject matter includes a computer 1002. It is to be appreciated that the computer 1112 can be used in connection with implementing one or more of the systems or components shown and described in connection with FIGS. 1-8. The computer 1002 includes a processing unit 1004, a system memory 1006, a codec 1035, and a system bus 1008. The system bus 1008 operates to communicatively couple system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. In addition, according to present innovations, codec 1035 may include at least one of an encoder or decoder, wherein the at least one of an encoder or decoder may consist of hardware, software, or a combination of hardware and software. Although, codec 1035 is depicted as a separate component, codec 1035 may be contained within non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. According to present aspects, the volatile memory may store the write operation retry logic (not shown in FIG. 10) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1002 may also include removable/non-removable, volatile/non-volatile computer storage medium. FIG. 10 illustrates, for example, disk storage 1014. Disk storage 1014 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1014 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016. It is appreciated that storage devices 1014 can store information related to a user. Such information might be stored at or provided to a server or to an application running on a user device. In one embodiment, the user can be notified (e.g., by way of output device(s) 1036) of the types of information that are stored to disk storage 1014 and/or transmitted to the server or application. The user can be provided the opportunity to opt-in or opt-out of having such information collected and/or shared with the server or application (e.g., by way of input from input device(s) 1028).

It is to be appreciated that FIG. 10 describes software that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002 and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, and wired and wireless Ethernet cards, hubs, and routers.

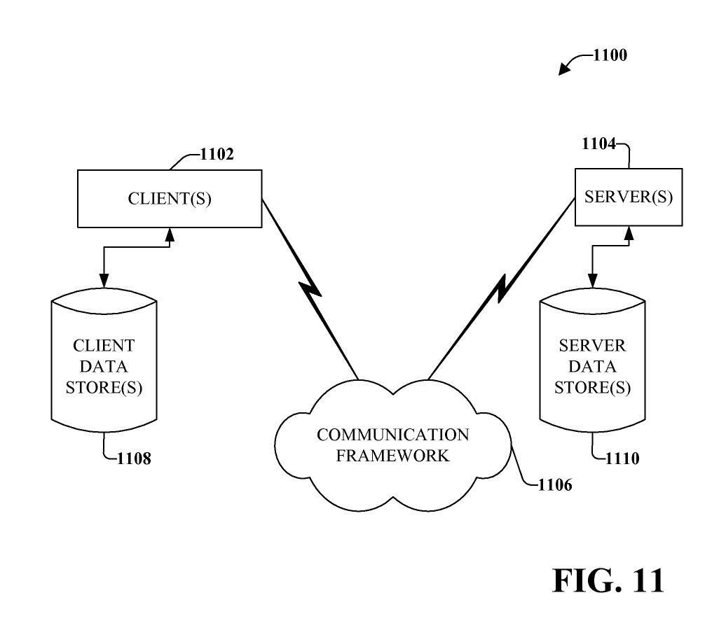

Referring now to FIG. 11, there is illustrated a schematic block diagram of a computing environment 1100 in accordance with this specification. The system 1100 includes one or more client(s) 1102 (e.g., laptops, smart phones, PDAs, media players, computers, portable electronic devices, tablets, and the like). The client(s) 1102 can be hardware and/or software (e.g., threads, processes, computing devices). The system 1100 also includes one or more server(s) 1104. The server(s) 1104 can also be hardware or hardware in combination with software (e.g., threads, processes, computing devices). The servers 1104 can house threads to perform transformations by employing aspects of this disclosure, for example. One possible communication between a client 1102 and a server 1104 can be in the form of a data packet transmitted between two or more computer processes wherein the data packet may include video data. The data packet can include a cookie and/or associated contextual information, for example. The system 1100 includes a communication framework 1106 (e.g., a global communication network such as the Internet, or mobile network(s)) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

In one embodiment, a client 1102 can transfer an encoded file, in accordance with the disclosed subject matter, to server 1104. Server 1104 can store the file, decode the file, or transmit the file to another client 1102. It is to be appreciated, that a client 1102 can also transfer uncompressed file to a server 1104 and server 1104 can compress the file in accordance with the disclosed subject matter. Likewise, server 1104 can encode video information and transmit the information via communication framework 1106 to one or more clients 1102.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system comprising:
a hardware decoder comprising:
a stream decoder that:
receives an input media stream having a plurality of data streams comprising a plurality of sub-partitions of a macroblock of video image data, the plurality of sub-partitions including at least a first sub-partition and a second sub-partition and each of the first sub-partition and the second sub-partition including different encoded data for reconstructing a same two-dimensional area of pixels of the macroblock and located in different data streams of the plurality of data streams;
decodes at least two of the sub-partitions concurrently using entropy decoding to generate intermediate symbol data; and
outputs the intermediate symbol data; and
a single decoding pipeline that:
receives the intermediate symbol data from the stream decoder;
orders at least some of the intermediate symbol data into scanned data; and
generates a reconstructed macroblock corresponding to the macroblock from the scanned data.

2. The system of claim 1, wherein the single decoding pipeline comprises:
a scan decoder that orders the at least some of the intermediate symbol data into the scanned data, the scanned data comprising quantized coefficient data of the macroblock; and
a motion vector decoder that derives a motion vector from the intermediate symbol data.

3. The system of claim 1, wherein the stream decoder includes a plurality of sub-stream decoder buffers respectively receiving a different data stream of the plurality of data streams.

4. The system of claim 1, wherein the single decoding pipeline comprises:
a discrete cosine transform component that performs a transformation on the scanned data, the scanned data comprising quantized coefficient data of the macroblock.

5. The system of claim 1, wherein the input media stream includes at least three data streams that respectively the first sub-partition, the second sub-partition and a third sub-partition of the macroblock, each of the first sub-partition, the second sub-partition and the third sub-partition including different encoded data for reconstructing the same two-dimensional area of pixels within the macroblock.

6. (canceled)

7. The system of claim 1, wherein the stream decoder includes a plurality of sub-stream decoder buffers that respectively receive a designated portion of the intermediate symbol data, each sub-stream decoder respectively coupled to a data stream of the plurality of data streams.

8. The system of claim 1, wherein the plurality of sub-partitions, includes at least one sub-partition having control data indicating how coefficient data of the macroblock is encoded, at least the first sub-partition having a set of luminance coefficient blocks corresponding to the two-dimensional area of pixels of the macroblock, and at least the second sub-partition having a set of chrominance coefficient blocks corresponding the same two-dimensional area of pixels of the macroblock.

9. The system of claim 8, wherein the set of luminance coefficient blocks includes a first set of luminance coefficient blocks in the first sub-partition and a different set of luminance coefficient blocks in a third sub-partition, and the stream decoder initiates processing of a luminance coefficient block from the first sub-partition before initiating concurrent processing of a chrominance coefficient block from the second sub-partition.

10. The system of claim 9, wherein the set of luminance coefficient blocks comprises an array of luminance coefficient blocks corresponding to an entire area of the macroblock, wherein the first sub-partition and the third sub-partition respectively include luminance coefficient blocks that alternate in the array of luminance coefficient blocks, and
respective luminance coefficient blocks above and contiguous to another luminance coefficient block are initiated for processing before the other luminance coefficient block.

11. A method comprising:
receiving, by a stream decoder of a hardware decoder, a plurality of data streams comprising a plurality of sub-partitions of a macroblock of video image data, the plurality of sub-partitions including at least a first sub-partition and a second sub-partition and each of the first sub-partition and the second sub-partition including different encoded data for reconstructing a same two-dimensional area of pixels of the macroblock and located in different data streams of the plurality of data streams;
decoding, by the stream decoder, at least two of the sub-partitions concurrently using entropy decoding to generate intermediate symbol data;
outputting, by the stream decoder, the intermediate symbol data;
receiving, by a single decoding pipeline of the hardware decoder, the intermediate symbol data output from the stream decoder;
ordering, by the single decoding pipeline, at least some of the intermediate symbol data into scanned data; and
generating, by the single decoding pipeline, a reconstructed macroblock corresponding to the macroblock from the scanned data.

12. The method of claim 11, wherein the receiving the plurality of data streams comprises receiving at least one sub-partition having control data indicating how coefficient data of the macroblock is encoded, at least one sub-partition having a set of luminance coefficient blocks, and at least one sub-partition having a set of chrominance coefficient blocks.

13. The method of claim 12, wherein the receiving the at least one sub-partition having the set of luminance coefficient blocks comprises receiving the first sub-partition and the second sub-partition respectively having different luminance coefficient blocks; the method further comprising:
initiating processing of a luminance coefficient block from the first sub-partition before initiating concurrent processing of a chrominance coefficient from the at least one sub-partition having the set of chrominance coefficient blocks and a luminance coefficient block from the second sub-partition.

14. The method of claim 12, wherein the first sub-partition and the second sub-partition respectively includes a first set of luminance coefficient blocks and a second set of luminance coefficient blocks that alternate in an array of luminance coefficient blocks that represent pixel values of an entirety of the two-dimensional area of the macroblock, and respective luminance coefficient blocks above and contiguous to another luminance coefficient block in the set of luminance coefficient blocks are initiated for processing before the other coefficient block.

15.-20. (canceled)

21. The method of claim 11 wherein the entropy decoding is arithmetic decoding.

22. The method of claim 11 wherein decoding the at least two of the sub-partitions comprises decoding the at least two of the sub-partitions concurrently based on an interdependency of the at least two of the sub-partitions, wherein the interdependency determines a decoding order for the plurality of sub-partitions.

23. The method of claim 11 wherein the plurality of sub-partitions includes a third sub-partition and a fourth sub-partition, the first sub-partition including encoded control data indicating how coefficient data of the macroblock is encoded, the second sub-partition including encoded coefficient data of the macroblock corresponding to luminance values of at least some of the pixels forming the macroblock, the third sub-partition including encoded coefficient data corresponding to first chrominance values of the pixels forming the macroblock and the fourth sub-partition including encoded coefficient data corresponding to first chrominance values of the pixels forming the macroblock.

24. The system of claim 1 wherein the entropy decoding is arithmetic decoding.

25. The system of claim 1 wherein the stream decoder is configured to decode the at least two of the sub-partitions concurrently based on an interdependency of the at least two of the sub-partitions, wherein the interdependency determines a decoding order for the plurality of sub-partitions.

26. The system of claim 1 wherein the plurality of sub-partitions includes a third sub-partition and a fourth sub-partition, the first sub-partition including encoded control data indicating how coefficient data of the macroblock is encoded, the second sub-partition including encoded coefficient data of the macroblock corresponding to luminance values of at least some of the pixels forming the macroblock, the third sub-partition including encoded coefficient data corresponding to first chrominance values of the pixels forming the macroblock and the fourth sub-partition including encoded coefficient data corresponding to first chrominance values of the pixels forming the macroblock.

27. The system of claim 1 wherein the stream decoder comprises a plurality of sub-stream decoders and a plurality of buffers, each of the plurality of buffers associated with a respective one of the sub-stream decoders and each of the sub-stream decoders receiving a respective one of the plurality of data streams.
